(19) United States
(12) Patent Application Publication
(10) Pub. No.: US 2009/0013534 A1
(43) Pub. Date: Jan. 15, 2009

(54) Razor

(76) Inventor: John Mallaridas, Lansdown, PA (US)

Correspondence Address: ETHAN D. CIVAN, 170 SOMERSET DRIVE, BLUE BELL, PA, 19422, US

(21) Appl. No.: 11/827,841

(22) Filed: Jul. 13, 2007

(51) Int. Cl. B26B 21/04; B26B 21/40

(52) U.S. Cl. 30/41; 30/50

(57) ABSTRACT

A multiple face razor, including blade head, a plurality of blade faces attached to the blade head, and a razor handle attached to the blade head.

### FIELD OF THE INVENTION

The present invention relates to razors.

### BACKGROUND

One difficulty in shaving is the constant need to clean a shaver's razor. The razor fills with shaving cream and hair after each stroke, leading to a substantially decreased rate of speed in shaving. It would therefore be desirable to increase the number of strokes that a shaver can complete before cleaning a razor is necessary.

### SUMMARY OF THE INVENTION

A multiple face razor, including blade head, a plurality of blade faces attached to the blade head, and a razor handle attached to the blade head.

### BRIEF DESCRIPTION OF THE DRAWINGS

FIG. 1 is an illustration of a first embodiment of the present invention.

FIG. 2 is an illustration of a second embodiment of the present invention.

FIG. 3 is an illustration of a third embodiment of the present invention.

FIG. 4 is an illustration of a fourth embodiment of the present invention.

### DETAILED DESCRIPTION OF THE PREFERRED EMBODIMENTS

The following definitions are provided to aid in construing the claims of the present application:

Blade: A single razor blade.

Blade Face: One or more blades usable together in a single assembly such that all of the blades in the blade face are oriented in such a direction that they can contact a shaver's face (or other surface being shaved) simultaneously).

Razor Handle: The portion of the razor grasped by the user when shaving.

Blade Head: The Blade Face or Faces of a razor and the mounting to which they are attached, whether the mounting is in the form of a cylinder, a prism of any form, a square, a triangle, or otherwise.

Multiple Face Razor: A razor having more than one blade face, such that not all blade faces are used simultaneously.

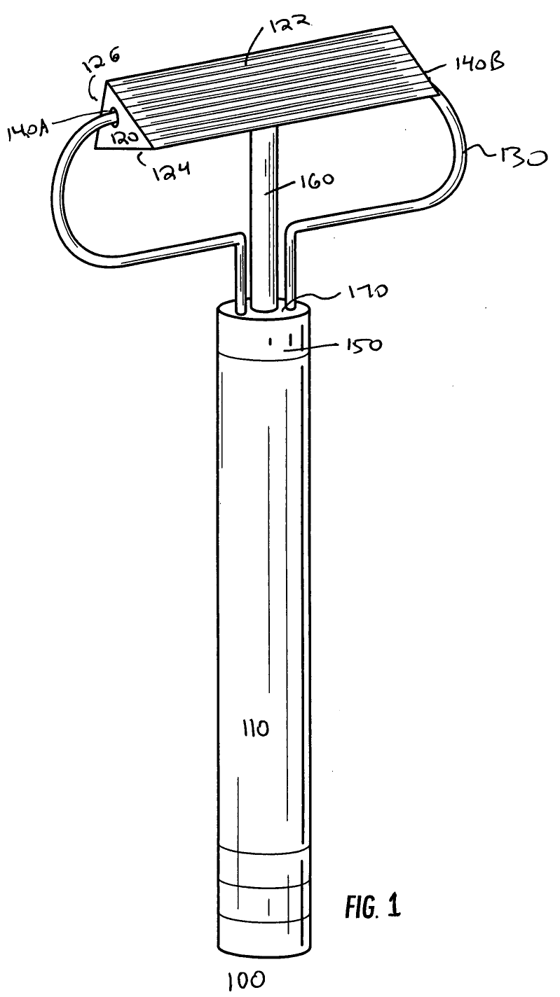

Referring to FIG. 1, in a first preferred embodiment, Multiple Face Razor 100 having three Blade Faces is illustrated. Handle 110 can be manufactured from metal or plastic and can be similar to any disposable razor or razor having disposable blades currently being manufactured. Handle 110 preferably is curved toward the user to present the Blade Head at a more convenient angle for a comfortable and close shave. Blade Head 120 is in the shape of a triangular prism to which are attached Blade Faces 122, 124, and 126. Blade Head 120 can be manufactured of metal or plastic, but is preferably manufactured from plastic for cost and weight reasons. Blade Faces 122, 124, and 126 are identical to each other and each include one or more standard razor blades, but preferably each include three or more razor blades for a closer shave. Blade Faces 122, 124, and 126 can be manufactured from metal or plastic, but are preferably manufactured from plastic (other than the razor blades themselves which are stainless steel for sharpness and other reasons). Each of Blade Faces 122, 124, and 126 can be generally similar to any multiple blade razor having disposable blades currently being manufactured.

Blade Head 120 is attached to Razor Handle 110 by wire mechanism 130, which is attached to Blade Head 120 at 140A and 140B and to Razor Handle 110 at 170. Wire mechanism 130 holds Blade Head 120 within it and a Blade Head can be changed by manually disengaging wire assembly 130, removing Blade Head 120, and replacing it with another Blade Head. Wire mechanism 130 is permanently attached to Razor Handle 110 at 170. Wire Mechanism 130 can be manufactured of metal, plastic, or any other strong, thin material, but typically, a relatively inflexible wire is utilized.

Button 150 is located on Razor Handle 110 and can be a button or other input device (such as a lever, toggle, or switch). Pressing on Button 150 causes Advancing Mechanism 160 to push on Blade Head 120, causing it to rotate one position. Advancing Mechanism 160 can be one or more rods, gears, springs, or other mechanical elements capable in combination of exerting sufficient force as a result of a single press of button 150 to advance Blade Head 120 by one position. Advancing Mechanism 160 is optionally battery powered.

In practice, a shaver initially utilizes Multiple Face Razor 100 in a manner identical to any standard razor. When the user needs to clean a Blade Face, however, the user presses Button 150, causing an additional, clean Blade Face to be brought into position for use. When all Blade Faces have been utilized, the user then cleans all of the Blade Faces simultaneously under a single stream of water. Thus, shaving time is considerably reduced.

In some embodiments, Advancing Mechanism 160 includes an advancing hook (not shown) and a series of notches, with one notch present on each Blade Face. In such embodiments, pressing on Button 150 causes the advancing hook to exert a rotational force on Blade Head 120 until the end of the advancing hook enters a notch at which time the advancing hook ceases moving and Blade Head 120 ceases rotating. In such embodiments, because the notches are evenly spaced one per Blade Face, Blade Head 120 rotates one Blade Face each time Button 150 is pressed. The advancing hook can be a wire hook, rod, or other advancing element and can also include one or more other mechanical elements, such as rods, gears, and springs, capable in combination of exerting sufficient force as a result of a single press of Button 150 to advance Blade Head 120 by one position. The advancing hook is optionally battery powered.

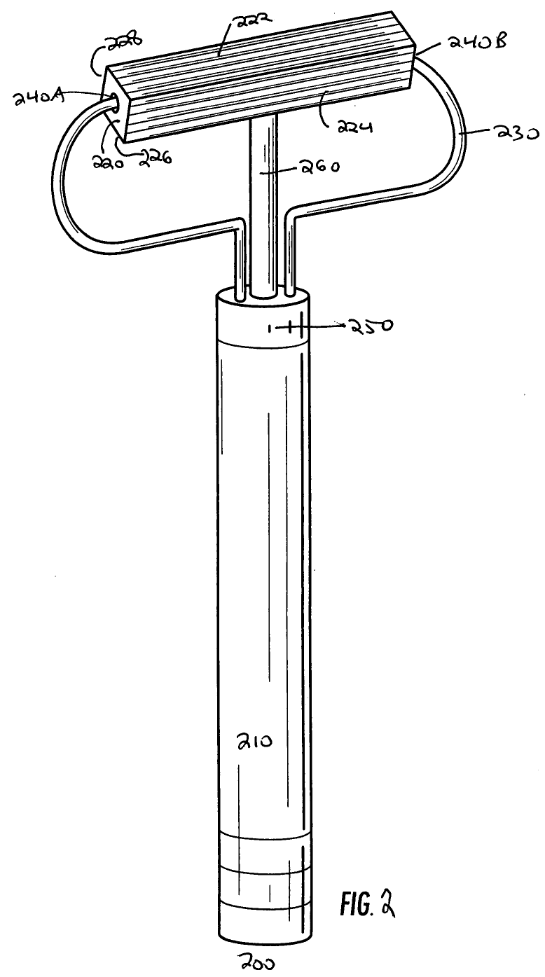

Referring to FIG. 2, a second embodiment of the present invention is illustrated. The second embodiment is identical to the first embodiment except that Blade Head 220 is in the shape of a rectangular prism to which are attached Blade Faces 222, 224, 226, and 228. In all other respects the second embodiment is identical to the first embodiment. In yet other embodiments, greater numbers of Blade Faces are utilized.

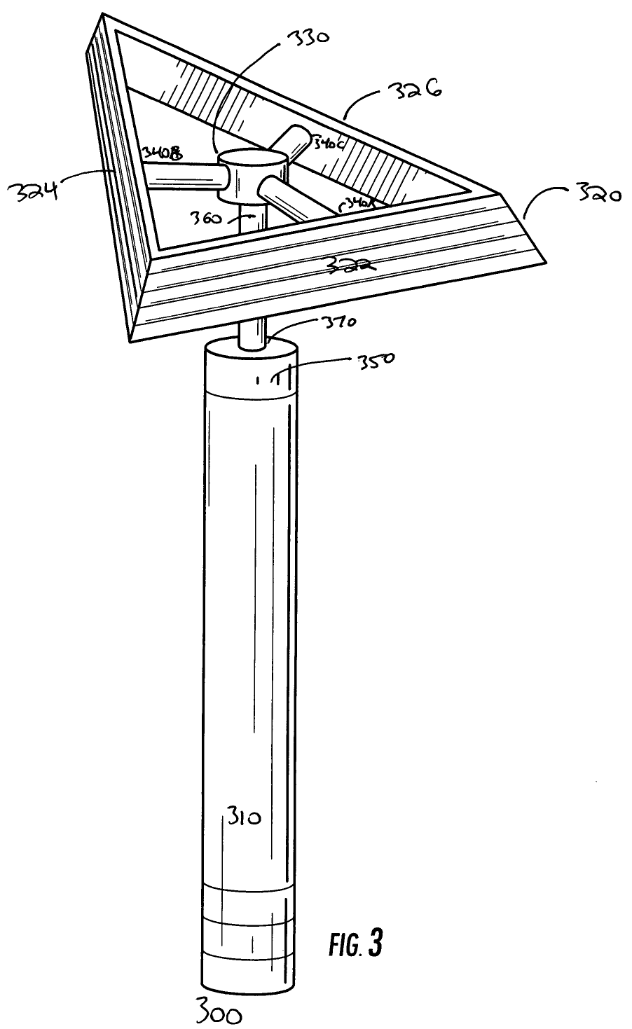

Referring to FIG. 3, a third embodiment of the present invention is illustrated. Multiple Face Razor 300 having three Blade Faces is illustrated. Handle 310 can be manufactured from metal or plastic and can be similar to any disposable razor or razor having disposable blades currently being manufactured. Handle 310 preferably is curved toward the user to present the Blade Head at a more convenient angle for a comfortable and close shave. Blade Head 320 is in the shape of a triangle to which are attached Blade Faces 322, 324, and 326. Blade Head 320 can be manufactured of metal or plastic, but is preferably manufactured from plastic for cost and weight reasons. Blade Faces 322, 324, and 326 are identical to each other and each include one or more standard razor blades, but preferably each include three or more razor blades for a closer shave. Blade Faces 322, 324, and 326 can be manufactured from metal or plastic, but are preferably manufactured from plastic (other than the razor blades themselves which are stainless steel for sharpness and other reasons). Each of Blade Faces 322, 324, and 326 can be generally similar to any multiple blade razor having disposable blades currently being manufactured.

Blade Head 320 is attached to Razor Handle 310 by wire mechanism 330, which is attached to Blade Head 320 at 340A, 340B, and 340C and to Razor Handle 310 at 370. Wire mechanism 330 is attached to Razor Handle 310 at 370. Wire mechanism 330 can be manufactured of metal, plastic, or any other strong, thin material, but typically, a relatively inflexible wire is utilized. A Blade Head can be changed by detaching the wire assembly at 370.

Button 350 is located on Razor Handle 310 and can be a button or other input device (such as a lever, toggle, or switch). Pressing on button 350 causes advancing mechanism 360 to push on wire assembly 330, causing Blade Head 320 to rotate one position. Advancing mechanism 360 can be one or more rods, gears, springs, or other mechanical elements capable in combination of exerting sufficient force as a result of a single press of button 350 to advance Blade Head 320 by one position. Advancing mechanism 360 is optionally battery powered. Alternatively, button 350 and advancing mechanism 360 can be omitted and Blade Head 320 can be advanced manually.

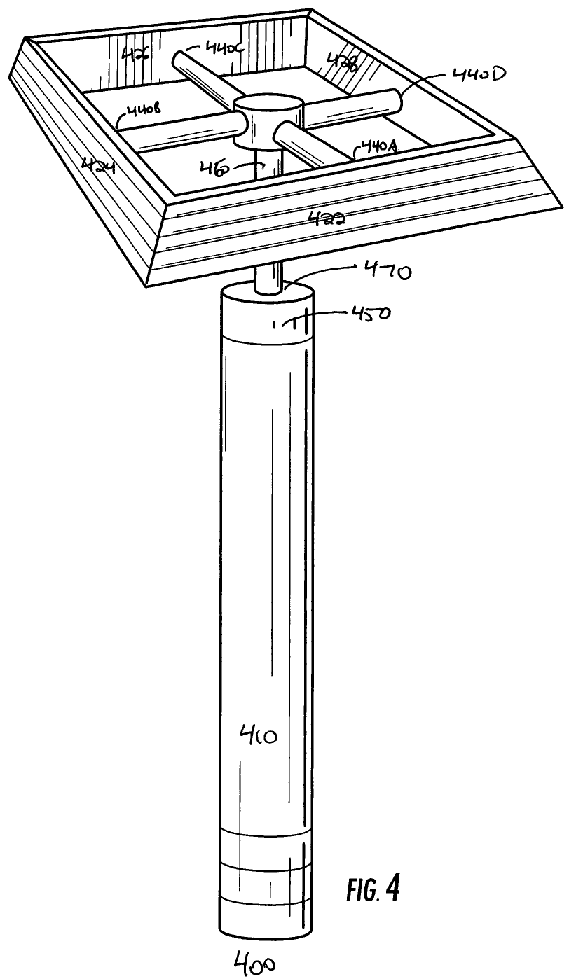

Referring to FIG. 4, the fourth embodiment is identical to the third embodiment, except that Blade Head 420 is in the shape of a square to which are attached Blade Faces 422, 424, 426, and 428. In all other respects the fourth embodiment is identical to the third embodiment. In yet other embodiments, greater numbers of Blade Faces are utilized.

The present invention may be embodied in other specific forms without departing from the spirit or essential attributes of the invention. Accordingly, reference should be made to the appended claims, rather than the foregoing specification, as indicating the scope of the invention.

That which is claimed is:

1. A Multiple Face Razor, comprising:
A Blade Head;
A plurality of Blade Faces attached to said Blade Head; and
A Razor Handle attached to said Blade Head.

2. The Multiple Face Razor of claim 1, wherein said plurality of Blade Faces comprises at least three Blade Faces.

3. The Multiple Face Razor of claim 1, wherein said plurality of Blade Faces comprises at least four Blade Faces.

4. The Multiple Face Razor of claim 13, wherein said Blade Head is capable of rotating with respect to said Razor Handle.

5. The Multiple Face Razor of claim 14, further comprising:
an input device attached to said Razor Handle; and
an advancing device connected to said input device,
wherein the user can provide input through said input device so as to cause said advancing device to cause said Blade Faces to rotate.

6. The Multiple Face Razor of claim 5, wherein said input device is a button;
wherein said advancing device is a rod; and
wherein when the user presses said button said rod contacts said Blade Head causing it to rotate.

7. The Multiple Face Razor of claim 6, wherein said advancing device is battery powered.

8. The Multiple Face Razor of claim 13, wherein said Blade Head is disposable.

9. The Multiple Face Razor of claim 5, wherein said input device is a button;
wherein said advancing device is a spring; and
wherein when the user presses said button said spring exerts a force upon said Blade Head causing it to rotate.

10. The Multiple Face Razor of claim 1, wherein said Blade Head is in the shape of a prism having two opposing sides to which said Razor Handle is attached and a number of intermediate sides between the two opposing sides equal to the number of Blade Faces in said Multiple Face Razor, one Blade Face being attached to each intermediate side.

11. The Multiple Face Razor of claim 1, wherein said Blade Head is in the shape of a regular geometric shape having a number of sides equal to the number of Blade Faces in said Multiple Face Razor, one Blade Face being attached to each side.

12. The Multiple Face Razor of claim 1, wherein said Razor Handle is curved.

13. The Multiple Face Razor of claim 1, wherein each of said Blade Faces includes multiple blades.
